(19) United States
(12) Patent Application Publication
(10) Pub. No.: US 2008/0275759 A1
(43) Pub. Date: Nov. 6, 2008

(54) Content Allocation

(75) Inventors: Daniel Parkes, San Francisco, CA (US); Anne Bezancon, Oakland, CA (US)

Correspondence Address: SF Bay Area Patents, LLC;Attn: Andrew V. Smith, Ph.D., 601 Van Ness Avenue, #1108, San Francisco, CA, 94102, US

(73) Assignee: 1020, INC., San Francisco, CA (US)

(21) Appl. No.: 12/108,481

(22) Filed: Apr. 23, 2008

Related U.S. Application Data
(60) Provisional application No. 60/913,444, filed on Apr. 23, 2007.
(60) Provisional application No. 60/913,451, filed on Apr. 23, 2007.

(51) Int. Cl. G06Q 10/00; G06Q 30/00

(52) U.S. Cl. 705/10

(57) ABSTRACT

A method of publishing and/or allocating content to particular destinations includes determining probable content destinations. One or more probable demographics are inferred based on the probable destinations along with one or more further characteristics relating to consumption of electronic content at the destination. Specific electronic content is selected and allocated and/or published to one or more electronic devices at one or more of the destinations.

### PRIORITY AND RELATED APPLICATIONS

This application claims the benefit of priority to U.S. provisional patent application No. 60/913,444, filed Apr. 23, 2007. This application is related to U.S. provisional patent application No. 60/913,451, and to United States published patent applications nos. 2007/0260531 and 2007/0260741. Each of these applications is incorporated by reference.

### BACKGROUND OF THE INVENTION

1. Field of the Invention

The present invention relates to publishing and/or allocating impressions of electronic content.

2. Description of the Related Art

A traditional online advertising campaign is illustrated at FIG. 1. Block 101 is labeled Advertiser. Block 101 represents an advertiser 101, e.g., Nike™, who wishes to promote a brand of a product, such as shoes, to a specific demographic.

Block 102 is labeled Advertising Agency. Block 102 represents an advertising agency 102, e.g., Ogilvy™, that may be called upon by the advertiser 101 to assist in the process of building an effective advertising campaign, including the creation of content and the selection of networks to publish the content.

Block 103 is labeled Traditional Content Server. Block 103 indicates that a traditional online ad server 103, e.g., Doubleclick™, may serve the content and provide performance tracking and reporting for the advertiser 101 and/or the advertising agency 102.

Block 104 finally illustrates a User Device 104. The user device 104 is how a consumer or user may receive generic or specific content relating to the product brand.

Traditional content serving may be used to publish the same content to many different consumers. In advertising, this results in a high-volume, low-margin business model. It is recognized by the inventors of the present invention that as more electronic devices are enabled to take advantage of both the location and time dimension, it is desired that content be more tailored to a unique user. In addition, the inventors recognize that it would also be advantageous to go beyond location and time, such as to consider other variables when building and publishing content for campaigns.

Doubleclick™, Inc. has patents in the online advertising space for publishing ad content to users. However, they fail to provide useful methods of allocating that content based on several considerations, described below herein, that may be applied to electronic advertising campaigns. For example, U.S. Pat. No. 5,948,061, incorporated by reference, describes methods for targeting the delivery of advertisements over a network such as the Internet. The '061 patent describes the compiling of statistics on individual users and networks and the tracking of advertisements to permit targeting advertising to individual users. In response to requests from affiliated sites, an advertising server transmits to people accessing the page of a site an appropriate advertisement based upon profiling of users and networks. In addition, U.S. Pat. No. 7,039,599, also incorporated by reference, describes methods for advertisement selection including receiving from an advertiser web site feedback representing user transactions at the advertiser web site, wherein the user transactions result from user responses to direct advertisements; and receiving requests to display direct advertisements to the user, as well as selecting, in response to the request, a direct advertisement for display based upon the advertiser feedback.

U.S. Pat. No. 5,937,392 describes an Internet advertising system including a database, a controller, and an ad server. The database has advertising campaign information, including identification information and frequency information for how often the ad is to be served. The ad server uses campaign information from the database to control the relative ratios of serving ads, the distribution of ads throughout the day, and any triggering mechanisms for controlling what ads are served. The '392 patent discusses how to control ratios and distribution of ads published to a user, but fail to describe content allocation and/or publishing in accordance with the advantageous techniques described hereinbelow.

U.S. Pat. No. 6,119,098 describes a system and method for targeting and distributing advertisements over a distributed information network including a client application that displays targeted advertisements on a subscriber's computer and a server that manages an advertisement database and provides advertisements to the subscriber's computer. Advertisements are specifically targeted to the subscriber based on a personal profile provided by the subscriber.

Microsoft™, Inc., has a patent, U.S. Pat. No. 6,990,462, that describes an algorithm for managing inventory of banner advertising. The '462 patent fails to take into account location or other advantageous considerations described hereinbelow.

Wayport™, Inc., has U.S. Pat. Nos. 5,835,061, 6,452,498 and 6,326,918 which describe a geographic-based communications service system having a mobile unit for transmitting and receiving information, and access points connected to a network. The access points are arranged in known geographic locations and transmit and receive information from the mobile unit. When one of the access points detects the presence of the mobile unit, it sends a signal to the network indicating the location of the mobile unit and the information requested by the mobile unit. Based on the signal received from the access point, the network communicates with information providers connected to the network and provides data to the mobile unit through the access point corresponding to the location of the mobile unit.

Pointcast™, Inc., has U.S. Pat. No. 5,740,549, which describes a system that uses a local workstation as part of an interaction with an advertising data server. An information administrator in each workstation establishes communication with the data server from time to time so as to update information items and advertisements stored in local memory with subsets of information items and advertisements stored by the data server.

U.S. Pat. No. 6,920,464 relates to yield management and price optimization. The techniques describes in the '464 patent involve time slotting for broadcasting.

None of the above-identified patents describes a technique for allocating or publishing specific content based on probable demographics nor probable destination indicia.

### SUMMARY OF THE INVENTION

A method of publishing content to particular destinations is provided. One or more probable content destinations are determined for publishing of electronic content to a group of one or more consumers of the content. One or more probable demographics of the group are inferred based on the determining of probable destinations and one or more further characteristics relating to consumption of electronic content at the destination. Specific electronic content is selected for the group according to the determining and inferring. The specific electronic content is published to one or more electronic devices of the group at one or more of the destinations.

The method may include allocating content impressions to be delivered. The allocating may include limiting to an estimated number of impressions. The allocating may include determining available impressions based on the estimated number minus a number of reserved allocations. The allocating may include determining numbers of impressions to allocate for each selected item of content.

The inferring may be based further on the date or dates or time or period of time, or combinations thereof. The method may exclude one or more particular dates or times, or both, for the consumption.

A method of allocating content impressions to particular destinations is also provided. One or more probable destinations are determined for allocating impressions of electronic content to a group of one or more consumers of the content. The destinations may include one or more probable consumer venues, brands, types or categories of destinations, vendors, demographics, rendering device formats or templates, display devices, or form factors, or combinations thereof. Specific electronic content is selected for delivery to the group based on the determining of probable destinations. One or more content impressions are allocated to one or more of the destinations according to the determining and selecting of the specific electronic content.

The allocating may include limiting to an estimated number of impressions. The limiting to an estimated number of impressions may include limiting to the estimated number of impressions in a certain period of time. The allocating may include determining available impressions based on the estimated number minus a number of reserved allocations. The allocating may include determining numbers of impressions to allocate for each selected item of content.

Any of the described methods may include determining a particular date or time or range of dates or period of time, or combinations thereof, for consumption of specific electronic content by the group.

Any of the described methods may include limiting content impressions to a predetermined number or to a range of dates or times, or combinations thereof.

The determining of probable destinations may include filtering certain businesses or geographic locations, or both, from the probable destinations or allowing only certain businesses or geographic locations, or both, as probable destinations, or combinations thereof.

The determining of probable destinations may include filtering certain categories of destinations from the probable destinations or allowing only certain categories of destinations as probable destinations, or both. The categories of destinations may include one or more hotels, bars, restaurants, airports, coffee shops, bookstores, or other types of businesses, or combinations thereof.

The determining of probable destinations may include filtering of certain destination vendors from the probable destinations or allowing only certain destination vendors as probable destinations, or both. The destination vendors may include one or more entities associated with one or more networks that publish content to the consumers.

The determining of probable destinations may include filtering certain brands from the probable destinations or allowing only certain brands as probable destinations, or both. The brands may include one or more entities associated with a property at which a destination is located.

The determining of probable destinations may include filtering destinations forecasted to result in less than a threshold number of impressions upon publication.

Any of the described methods may include ordering the probable destinations based on predetermined values associated with one or more characteristics of the destinations. The one or more characteristics may include one or more geographic locations, categories, brands, vendors, dates, times, or impression forecasts, or combinations thereof.

The determining of probable destinations may include assessing probable rendering device formats or templates, form factors, or display devices for publishing the content, or combinations thereof.

The selecting of specific content may include filtering location-aware content that fails to be within a predetermined geographic radius of the destination.

The selecting of specific content may include filtering one or more restricted content types. For example, text content may be selected and image content filtered out, or vice-versa. Also, audio content may be selected or filtered out.

The selecting of specific content may include filtering content having greater than a predetermined dimension and/or filtering content according to one or more destination publishing rules and/or filtering content according to one or more predetermined date criteria. The date criteria may include an end date, a date range, or a certain number of days or hours, or combinations thereof, and/or may include a promotional date range within a temporally-larger campaign.

One or more processor-readable media are also provided which have embodied therein program code for programming one or more processors to perform any of the methods described herein.

### BRIEF DESCRIPTION OF THE DRAWINGS

FIG. 1 illustrates a traditional content serving system and method.

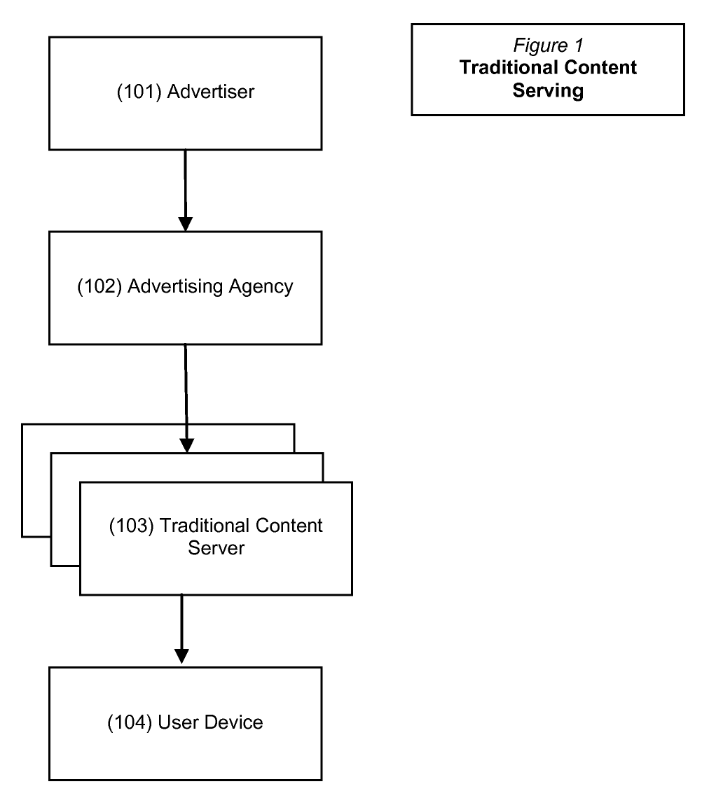

FIG. 2 illustrates a content platform and allocation in accordance with certain embodiments.

FIG. 3 illustrates a content allocation flow in accordance with certain embodiments.

FIG. 4 illustrates a sub-process of the content allocation flow of FIG. 3 for determining destinations for content based on various factors and/or restrictions in accordance with certain embodiments.

FIG. 5 illustrates a sub-process of the content allocation flow of FIG. 3 for selecting and/or filtering specific content to allocate and/or deliver to the destinations determined in accordance with FIG. 4 and certain embodiments.

FIG. 6 illustrates a sub-process of the content allocation flow of FIG. 3 for allocating impressions of content in accordance with certain embodiments.

### DETAILED DESCRIPTION OF THE EMBODIMENTS

The present invention describes a method and system for managing campaigns in an effective and efficient manner. In particular, it details an algorithm for allocating the publishing of content to limited space on a user device.

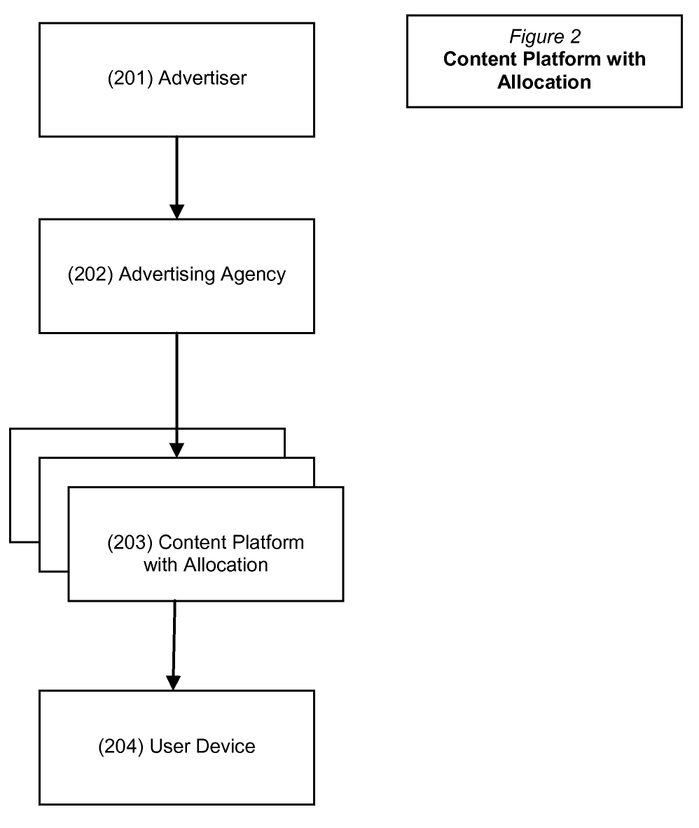

In doing so, we have solved an important and complicated need. FIG. 2 illustrates a process in accordance with several embodiments. At block 201, an advertiser, for example Nike™, wishes to promote a brand of shoes to a specific demographic competing in the upcoming NYC marathon. A location dimension may restrict the advertising to the bounds of NYC, but may also include Philadelphia or other parts of Eastern Pennsylvania, parts of New Jersey and/or Upstate New York. The time dimension may be constrained to the three days leading up to and including the marathon, but may continue after the marathon, e.g., showcasing the shoes worn by the winner. Further, Nike™ may wish to direct users to a nearby Foot Locker™ having a promotion including discounts on Nike™ running shoes. The location dimension may further constrain the campaign to the closest store in NYC (and surrounding area) to a consumer's actual location.

FIG. 2 also shows Advertising Agency 202, for example Ogilvy™, that may assist the advertiser 201, e.g., Nike™, in the process of building an effective advertising campaign. The agency 202 may assist the advertiser 201 in the creation of content and the selection of networks to publish the content.

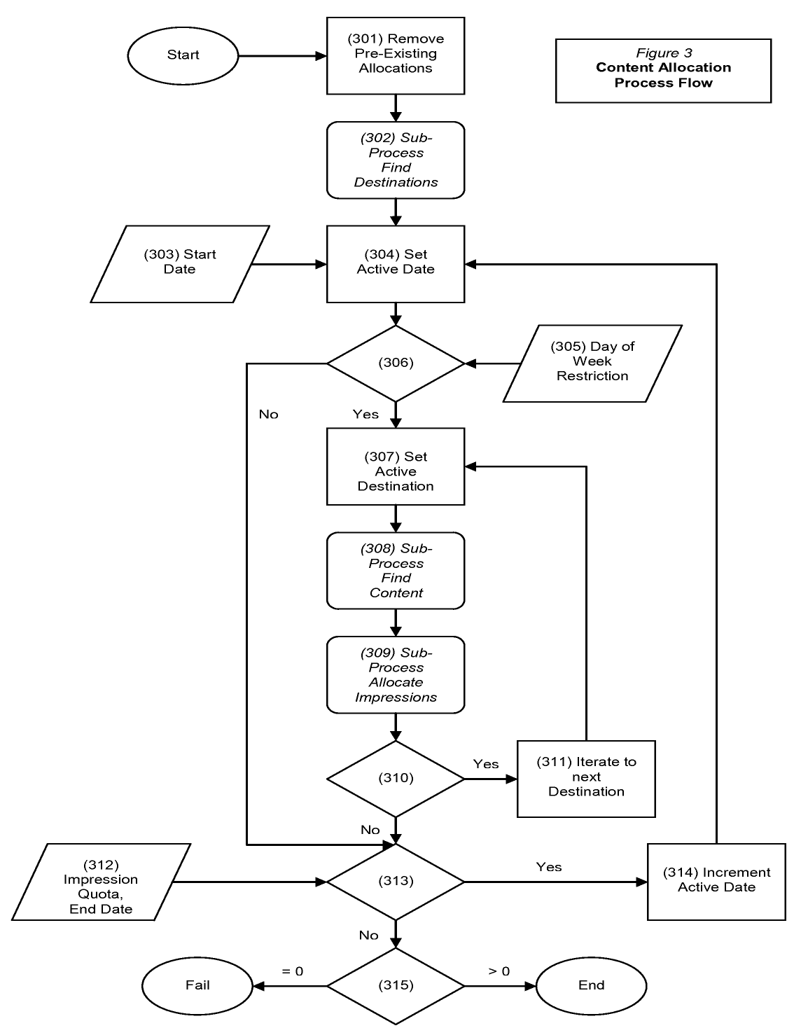

The Content Platform 203 of FIG. 2 allocates the content in the campaign and then publishes appropriate content selectively to consumers. The allocation and/or publication of content selectively to consumers is described in more detail with respect to FIGS. 3-6 and advantageously provides an effective and efficient advertising technique. Finally, a consumer or other user receives the specifically-selected content on a user device 204.

### An Analogy

Consider an example wherein there are 300 seats on a plane. Regardless of how many seats are reserved, only 300 passengers can possibly be accommodated on a given flight. In the case of over-booking, some passengers are going to have to be bumped and in the case of under-booking, seats can be filled with standby passengers or the seats may remain empty.

Clearly, a goal is to end up with the exact number of passengers to fill the plane without discounting any fares very significantly. Business-wise, it is generally desired to receive a larger total sum of money from the passengers who board the aircraft. It is also desired to pick passengers in an intelligent way to further business interests. There are several competing business interests to be considered in parallel to determine which passengers get seats and which passengers do not.

There may be a profit policy, i.e., to make the most money possible for each seat on the plane. If there are 400 passengers looking to buy a ticket to get on the plane, it may be determined to pick the 300 that are willing to pay the most, at least initially. Another way may be to offer several flights a day, so that passengers can select the higher demand (more expensive) morning or afternoon flight or the lower demand (cheaper) red-eye flight. Another way may be to divide the seats into tiers (First Class, Business Class, Coach) so that enhanced or streamlined service may be provided to passengers according to their preferences and abilities to pay.

There may be policies that directly conflict with the profit policy. For example, discounts may be offered for reserving a seat early, because this provides the value of ensuring a certain number of passengers will be flying on the plane. There may be accommodations for ‘frequent flyer’ passengers or persons that fly a lot on the airline, and passengers may be accommodated that have already been bumped from one flight due to over-booking.

### Content Allocation

The basic metric for content allocation is not the number of seats per flight but the total number of impressions per day for a given destination. Specifically, an impression may include an exposure of a piece of content (for example, an advertisement) to an end user. A destination may include a region, place, geographic or virtual location, device, building, room, business or government service location or municipality, vehicle, kiosk, fixed or handheld or otherwise portable or wearable processor-based apparatus, or other tangible or electronic business, recreational or casual event, event location or event locator at which content may be published to an end user. A region can include geometries such as polygons (e.g., generally in the “plane” of the surface of the Earth) or non-planar surfaces, or polyhedrons, and can be of any regular, irregular, selected or arbitrary size and/or shape.

It is desired to display content for which a highest price may be obtained per impression. There also may be competing goals, including the desire to display certain content over other content to meet time-constraints or other policy considerations. The combinations of rules that describe the goals may be encapsulated into procedures under which a campaign may be published.

Allocation includes the process of allocating impressions to content. There are several factors that make content allocation more complicated than traditional yield management for inventory. Impressions are generally not the same as widgets in a warehouse. If a destination is sponsored, then one piece of content can consume all or part of the forecast impressions for a destination. Otherwise, each piece of content may be limited to being delivered a certain percentage of the time based on how much of the allocation it consumes.

The number of impressions may not actually be precisely known before they are published, and so a forecast of the number of impressions may be determined for one or more destinations. Initially, the forecast can be estimated. Going forward, historical data may be used to tune the forecast using, for example, exponential smoothing, or a combination of estimation and forecasting.

A top-level flow in accordance with certain embodiments is illustrated in FIG. 3. At 301, pre-existing allocations may be removed. If a campaign has already been allocated or reserved, then the existing allocations are preferably removed before new ones are created.

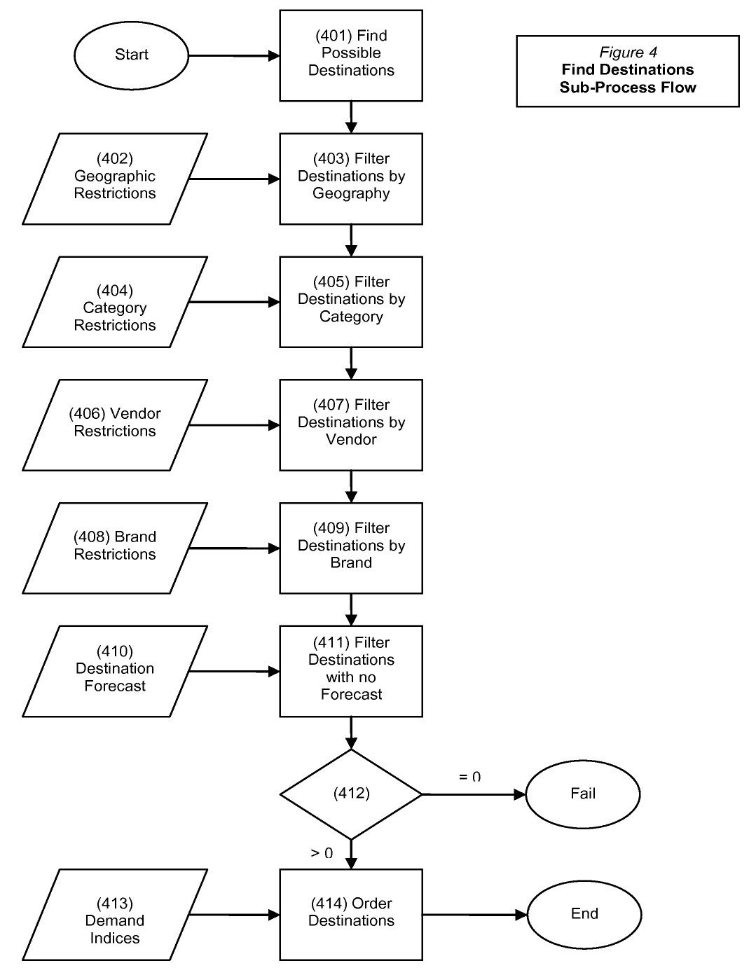

A sub-process of finding destinations 302 is next illustrated in the process of FIG. 3. This sub-process 302 is illustrated in greater exemplary detail in FIG. 4. The output of this sub-process 302 is a list of valid destinations to use in the allocation algorithm.

A start date 303 may be optionally determined or received. A start date 303 may be a date at which an advertiser wants to start a campaign. In the example of the NYC marathon, the start date may be three days before the marathon starts.

An active date 304 may be set. The active date 304 may be a temporary value that is used in the allocation algorithm. The active date 304 may reflects the current date that is being processed in the algorithm. The active date 304 may be initialized to the start date of the campaign, and may include dates thereafter for a predetermined duration, e.g., three days, after the start date.

A day of the week restriction 305 may be provided to exclude and/or specifically include one or more days of the week. The day of week restriction 305 may be a set of boolean values that indicate, for each day of the week, whether it is to be included or not in the campaign. For example, a campaign may be generated that is only active during the working week. In this example, Monday, Tuesday, Wednesday, Thursday and Friday would be defined as included in the campaign, while Saturday and Sunday would be defined as not included in the campaign.

At block 306 of FIG. 3, a current day of the week is considered as being valid or invalid. The day of week of the active date is compared with any day of the week restrictions 305 based on which it is determined whether the current day of the week is included or not in the campaign. If the active day of week is included in the campaign based on the set of day of week restrictions 305, then the process of FIG. 3 continues at 307. Otherwise, the process moves to block 313 since no impression is to be allocated for the current day of the week.

An active destination 307 may be set. The active destination 307 may be a temporary value that is used in the allocation algorithm. The active destination 307 may reflect a current destination that is being processed in the algorithm. The active destination 307 may be initialized to the first destination in the destination list output from block 302 of FIG. 3.

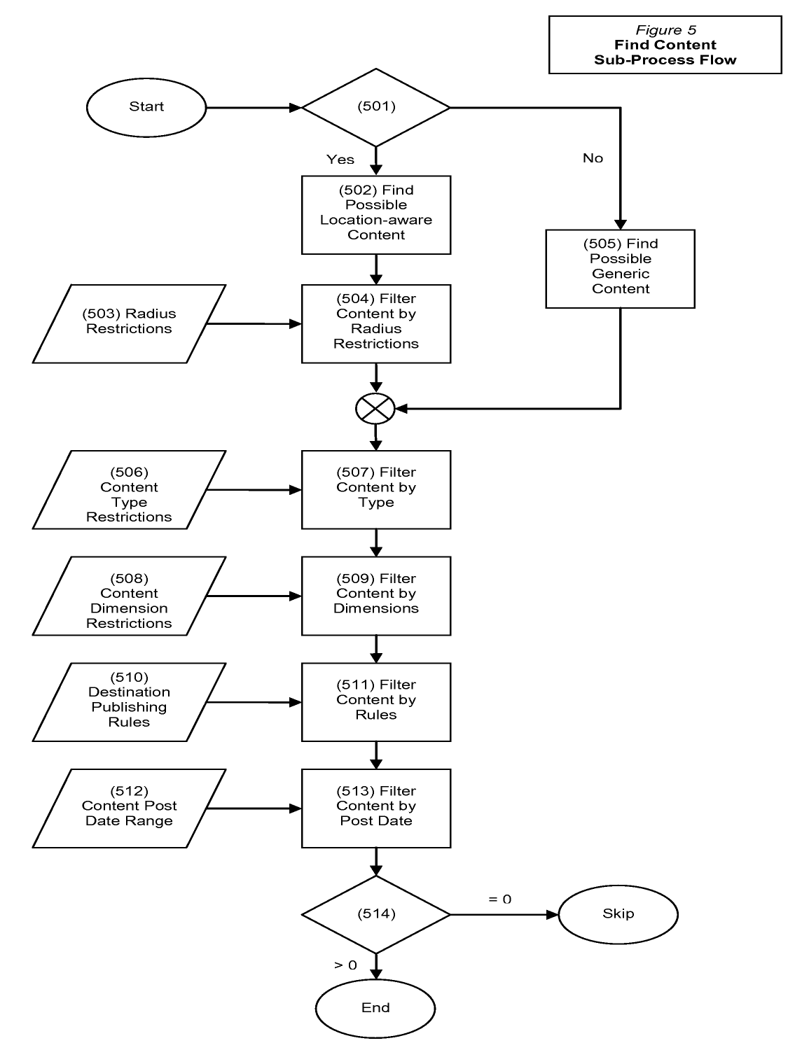

A sub-process of finding content 308 is provided in greater exemplary detail at FIG. 5. The output of the sub-process 308 may be a list of valid content to use in the allocation algorithm.

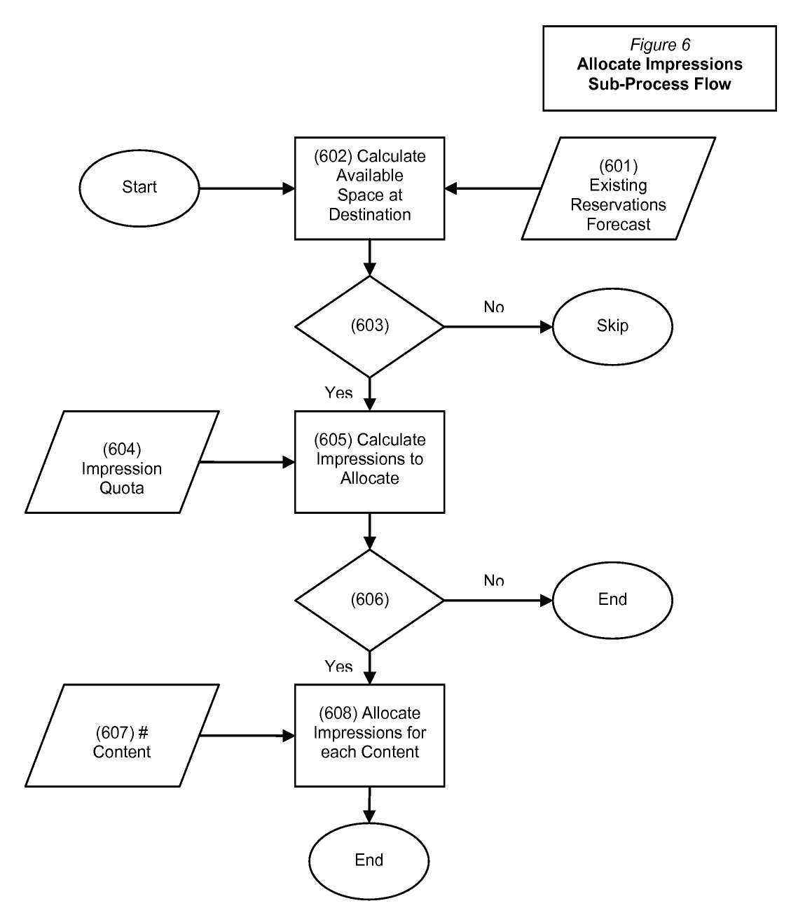

A sub-process of allocating impressions 309 is provided in greater exemplary detail at FIG. 6. The output of this sub-process is a list of allocations for the given destination and content.

At block 310 of FIG. 3, it is determined whether more destinations are available for allocating impressions. It is determined at 310 whether there are any more destinations that are not yet processed for the active date. If the entire list of destinations has not yet been iterated, then the process moves to block 311, and otherwise proceeds to block 313.

At block 311, the process iterates to a next destination. A next destination is fetched in the destination list output from block 302 of FIG. 3. The process then returns to block 307

At block 312, an impression quota and/or end date may be optionally provided. The impression quota may provide a limit defined by the advertiser or otherwise of how many impressions to publish for a given set of content. An end date may be provided as a date that the advertiser wishes to end the campaign, e.g., even if a maximum or estimated number of impressions has not been reached.

At block 313, it is determined whether there are more impressions to allocate. There are (at least) two ways to determine whether there are any more days to process in the allocation algorithm. The impression quota may have been reached based on already processed allocations or the campaign end date may have been reached. In the example of the NYC marathon, the end date may be set to the actual day of the marathon. If there are more impressions to allocate, then the process moves to 314 and otherwise to 315.

At 314, the active date is incremented. The next date after the current active date is fetched at 314 and the process returns to block 304.

At 315, it is determined what the number of allocations is. It is determine whether there are any allocations at all based on all the previous processing in the algorithm. If the number of allocations is greater than zero, then the allocation algorithm has completed successfully. The content would preferably be delivered according to the determined allocation(s). If the number of allocations equals zero, then the algorithm has simply failed to allocate any impressions of selected content in this campaign to any of the determined destinations. In the case of failure, the process may be run again with eased restrictions on selections of content, determination of destinations and/or other parameters of allocating impressions, or the campaign may be left as a null campaign.

### Finding/Selecting Destinations

A sub-process flow in accordance with certain embodiments to find the list of destinations is illustrated in FIG. 4. A number of possible destinations is preferably first determined at block 401, after which the listing of possible destinations is filtered to a smaller number. In another embodiment, the process begins with a null set and destinations are added that meet certain constraints, while a hybrid of these methods may be used where certain destinations are affirmatively added, certain destinations are filtered, and contention mechanisms are installed for determining whether a destination to be both affirmatively added or filtered out should be included or excluded.

As to finding the possible destinations at 401, the full list of possible destinations is first assembled. Some initial restrictions may be applied automatically or semi-automatically based on access restrictions and destination status (active, inactive).

Geographic restrictions 402 are a set of criteria that limit the possible set of destinations based on their objective physical location. There are many different ways that the geographic restrictions can be expressed. For example, a set of postal codes may be used, or a set of latitude/longitude coordinates that define a geometric polygon may be used, or city, state, country, county, city block, city borough, city sector, neighborhood, ranch location, landmark or preserve designation, body of water, island, coordinate sector on a map or other designation of area somewhere on the globe. In addition, a range, ranges or single limitations (max or min) on altitude may be included either in meters above or below sea level, or indirectly by designating the third floor or the mezzanine or the penthouse, or the banquet level or the conference room level or on the bay or on the bridge or in air space or underwater or in outer space, for example. In the NYC marathon example, geographic restrictions to just the island of Manhattan might be used, or alternatively the others of the five boroughs may be included, along possibly with parts of New Jersey, Pennsylvania and/or upstate New York. It is also possible to have a final listing of destinations that are not filtered by any geographic restrictions.

At block 403 of FIG. 4, the destinations are filtered by geography. The geographic restrictions determined at block 402 are used to filter the list of possible destinations determined at block 401. For each possible destination, it is determined whether the destination meets the geographic criteria or not. The destination is removed from the list of possible destinations if it does not meet the criteria for inclusion or such destination may be removed because it meets an exclusionary restriction. If no geographic restrictions are supplied, then the list of possible destinations should remain unchanged at block 403 while the process continues to blocks 404 and 405.

At block 404, category restrictions are determined, if any. The category restrictions 404 may include a set of inclusionary and/or exclusionary criteria that limit the possible set of destinations based on a subjective categorization hierarchy. For example, destinations could be categorized as a hotel, bar or restaurant, or even an airport, residence or residential neighborhood, bus, bus station, train, train station, tour ship, tourist site, mall, college or university, hospital, library, street, parking or scenic viewing area, or other category of places. In one example, category restrictions only to destinations that are hotels may be set which would match only destinations that are in fact categorized as hotels, although motels, campgrounds, bed and breakfasts, shelters or other places where people sleep temporarily may be included or excluded. Category restrictions 404 can be inclusive or exclusive. For example, an exclusive category restriction with just the hotel category would match all destinations that are categorized as a bar or restaurant or any other category besides hotels. It is possible to move to blocks 406 and 407 in the process of FIG. 4 without changing (adding to and/or subtracting from) the list of possible destinations based on any category restrictions.

At block 405, the destinations are then filtered based on the category restrictions determined at block 404. The category restrictions 404 are set to a category filter 405 to modify the list of possible destinations obtained at 401 and modified at the geography filter 403. For each possible destination, it is determined whether the destination meets the category restriction or not. The destination is removed from the list of possible destinations if it does not meet the criteria (or in an alternative embodiment, the destination is added to the list if it meets the criteria). If no category restrictions are supplied, then the list of possible destinations should remain unchanged and the process moves to blocks 406 and 407.

Vendor restrictions are considered at block 406. The vendor restrictions 406 may include a set of criteria that limit the possible set of destinations, that began at 401 and that has been filtered through 403 and 405, based on a destination vendor. A destination vendor may represent the business entity that owns and/or manages a network that publishes content to an end user, or that otherwise controls publication of the content. There may be multiple vendors associated with a single publication of content and/or with multiple publications one or more items of content and/or with an entire campaign or otherwise-determined sub-set of a campaign. For example, Earthlink™ might be a vendor when defining destinations in the Anaheim municipal Wi-Fi deployment. A vendor restriction with just the Earthlink™ vendor in its set would match destinations that have their vendor set to Earthlink™. Vendor restrictions can be inclusive or exclusive. For example, an exclusive vendor restriction with just the Earthlink™ vendor would match all destinations that do not have their vendor set to Earthlink™. It is not required to supply any vendor restrictions at block 406.

The list of possible destinations is filtered by vendor at 407 based on the restrictions determined at block 406. The vendor restrictions may be used to filter the list of possible destinations that began at 401 and has been filtered by geography at 403 and category of destination at 405. For each possible destination remaining in the list, it is determined whether the destination meets the vendor restriction or not. In the example embodiment of FIG. 4, the destination is removed from the list of possible destinations if it does not meet the criteria (alternative embodiments would add the destination if it met the vendor criteria and was not otherwise excluded). If no vendor restrictions are supplied, then the list of possible destinations should remain unchanged and the process moves to blocks 408 and 409.

Brand restrictions may be added at block 408. The brand restrictions may include a set of criteria that limit the possible set of destinations based on the destination brand. A brand may represent a business entity that owns, controls, does business at or with, manages, has franchise contracts at, has goods and/or services on sale at, includes a link from or to, or is otherwise associated with the physical or virtual property at which a destination is located. For example, Hilton™ may be a brand restriction when it is desired to define destinations that reside inside the Hilton™ San Francisco Hotel. A brand restriction with just the Hilton™ brand in its set would match destinations that have their brand set to Hilton™. Brand restrictions can be inclusive or exclusive. For example, an exclusive brand restriction with just the Hilton™ brand would match all destinations that do not have their brand set to Hilton™.

At block 409, the destinations are filtered by brand. Any brand restrictions from 408 are used to filter the list of possible destinations. For each possible destination, it is determined whether the destination meets the brand restriction or not. The destination is removed from (or added to) the list of possible destinations if it meets or does not meet the certain specified brand criteria. If no brand restrictions are supplied at 408, then the list of possible destinations should remain unchanged at 409.

At block 410, a destination forecast may be provided. A destination forecast 410 may represent an expected number of impressions to be published at a particular destination or group of destinations based on historical data, trend information, or other predictive formulae. Destinations having a zero forecast or null or no forecast for any impressions may be filtered at block 411. Moreover, for forecasts with limited impressions allocated, certain destinations may be removed while others are matched to the limited impressions forecast. The destination forecast 410 may be used to filter the list of possible destinations that have already been processed through blocks 401-409. However, the filters 403, 405, 407, 409, and 411, and any of multiple further possible filters, may be selectively applied in any order or not applied at all. In one example, for each possible destination, it is determined whether the forecast 410 is equal to zero or not. The destination is removed if the forecast equals zero, as there is no projected forecast at this destination and so it should not be included in the list of possible destinations in the process as it moves to block 412.

After applying all the possible or selected filters to the list of possible destinations 401, it is determined whether there are any valid destinations remaining in the list at block 412. If the list of possible destinations remaining at block 412 is greater than zero, then the process is moved to block 413. Otherwise, the allocation algorithm is determined to have failed. At this point, the process may be restarted with eased restrictions or it may be determined to nullify the process.

Demand indices may be provided at block 413. The demand indices 413 may be used to apply an order to the remaining list of destinations from 412. The demand indices 413 may include a set based on analysis that determines a relative “value” of each destination. The demand indices 413 can be determined from consumer polling, product or service sales data, predictions or trend information. For example, a Wi-Fi Access Point in the Hilton in midtown Manhattan may be considered to be more valuable than a Comfort Inn in Sydney, Nebr. based, e.g., upon total number of potential impressions and/or on the demographic that will likely be exposed, e.g., certain persons may be more likely to purchase a product or service based on the impression than others. Demand indices 413 may also be different based on the configuration of the advertising campaign. Different campaigns may have different goals and so may value destinations differently based on how relevant they are in achieving those goals.

Based on the demand indices determined in block 413, the destinations remaining in the destination list 401 following the filtering at 403, 405, 407, 409 and 411 are ordered at block 414. Alternatively, destinations may be added at blocks 403, 405, 407, 409 and 411 to an initially null list or to a listing of destinations that for whatever reason has been previously determined to be on the list. The demand indices 413 may be used to order the list of destinations. If the demand indices are different, then the destinations with a higher demand index will be moved to the start or priority location within the list. If all the demand indices are equal, then the list may be arbitrarily ordered, or the demand indices may be run again with greater sensitivity in order to distinguish the destinations on the list.

### Finding/Selecting Content

A sub-process flow in accordance with certain embodiments to find or select certain content or a list of content items is illustrated in FIG. 5. At block 501, the process determines whether certain content is “location-aware”. If the content is location-aware, then the content is particularly relevant to one or more certain locations, places, venues, or other destinations, or is particularly irrelevant to one or more certain locations, places, venues or other destinations. Content can also be generic, i.e., not particularly relevant or irrelevant to any destination, as for example in traditional online advertising. For generic content, the process moves directly to block 505 past blocks 502, 503 and 504. However, content that can be associated strongly or weakly or elsewhere on a sliding or discrete scale from having a strong to weak relationship with a location, venue or other destination, then the content is considered location-aware. By location-aware, it is meant that a content item may have a positive or negative weak to strong relationship with a destination, particularly to its geographic location, but also potentially to other characteristics of a possible destination including or besides geographic location. The location-aware content could be associated with a specific location or venue like a retail store, or it could be associated with a region like Manhattan, or an international chain of coffee shops like Starbucks, or particularly with airports, wherever they may be located. If the content is location-aware, then the process moves to block 502.

At block 502 possible location-aware content is found. Based on an initial set of restrictions, a full list of possible location-aware content is generated at block 502. Initial restrictions may include access restrictions, and/or content status (active, inactive), for example.

A radius restriction may be determined block 503. The radius restriction 503 may include a set of one or more restrictions that determine proximity between locations. Proximity is a subjective measure and may be determined differently on a campaign by campaign basis depending on the campaign goals, and proximity may differ between certain destinations in a campaign. There are many methods by which to determine whether two locations are proximate. For example, two point locations may be compared and a linear distance threshold (as the crow flies) may be used to determine whether locations are proximate or not. If a campaign is location-aware, then a radius restriction is used even if the magnitude is by default. The radius restriction may be in terms of time, i.e., the average time it takes to cross between the two destinations, and the radius restriction may have a non-circular shape, for example, having a shape that tends to protrude in a desired direction toward or away from a more or less relevant demographic.

Location-aware content is filtered by radius restrictions at block 504. The radius restrictions 503 are used to find the list of possible location-aware content for a given destination. For each possible piece of content, it is determined at 504 whether or not the location meets the proximity restrictions of the radius criteria of block 503. The content is removed from the list of possible content if it does not meet the criteria (or added if it meets the criteria, or moved to a contention matching group of content items that meet certain criteria but that do not meet one or more other criteria).

Possible generic content is found at block 505. Based on an initial set of restrictions, a full list of possible generic content is provided at 505. Generic content is defined in this context as not being location-aware or more generally as not being destination-aware. Initial restrictions may include access restrictions, and/or content status (active, inactive).

At block 506, content type restrictions are determined. Content type restrictions limit the possible set of content based on the type of content. Each destination may be restricted to including certain content types or may exclude certain content types. A content type restriction may also be any reasonable restriction that considers that the content is to be published to one or more certain devices at one or more certain destinations and more or less fine-grained control may be desired over the types of content that are published. For example, a destination may only support text content type. Content with text content type will pass the restriction and content with image and or audio content type will fail in this example. Mixed content may also be stripped so that content having image and text might be stripped down only to text and saved into a new file which is included in the list after filter 507. A destination should describe what content types it can publish, such that the content type restriction is not empty, i.e., unless a destination is so versatile that it can include all content types.

Content is filtered at block 507 by content type restrictions. The content type restrictions are used to filter the list of possible content. For each possible piece of content, it is determined whether the content meets the content type restriction or not. The content is removed from the list of possible content if it does not meet the criteria or is added if it does meet certain criteria or it is stripped (see above) or moved to a contention matching list of content that both meets and fails to meet certain criteria and that will be more sensitively judged in a further contention matching process.

At block 508, content dimension restrictions are provided. The content dimension restrictions 508 limit the possible set of content based on the content's dimensions. Each destination can only render, display, show, project or otherwise exhibit certain sizes of content, and it may only be capable of rendering certain types of content of a certain size. For example, a destination may be capable of displaying content that is 300 pixels in width and 250 pixels in height (or smaller). Content with dimensions 300×250 (or less) will pass the restriction while content with dimensions 425×250, e.g., will fail or be modified to pass such as by sub-sampling the original content. A destination should describe what dimensions it can publish, so that the content dimension restriction is not empty unless it is so versatile that it could be accepted at pretty much any destination dimension or at pretty much none or it may provide some special information such as compression or sub-sampling information for a smaller destination that can only render the compressed or sub-sampled content versions. In any event, content may or may not describe its dimensions. If content does not describe its dimensions, it should be assumed to be able to fit in any destination dimensions.

Content may be filtered by dimension at block 509. Using the content dimension restrictions of block 508, the list of possible content may be filtered. For selected content or for each possible piece of content, it may be determined whether the content meets the dimension restriction or not. Content may be removed from the list of possible content if it does not meet the criteria or it may be added if it meets the criteria or it may be modified to meet the criteria in which case only the modified content would make the list and continue through to the blocks 510 and 511.

Destination publishing rules may be provided at block 510. A destination network may have detailed restrictions on the type of content that can be published on the network. These restrictions may make up or form part of the publishing rules 510. For example, a Wi-Fi hotspot may be published in a Hilton hotel which does not allow content that promotes a Sheraton hotel or perhaps any other brand of hotel. The list of publishing rules 510 can be custom tailored to a particular destination, vendor or network. The destination need not supply a set of destination publishing rules 510. The publishing rules 510 may include decency restrictions, restriction regarding political ads or restrictions within certain regions of authority of local governments.

At block 511, content is filtered by the destination publishing rules 510. The destination publishing rules 510 are used to filter the list of possible content. For each possible piece of content remaining after 501-509, it is determined at block 511 whether content meets certain publishing rules or not. A content item is removed from the list of possible content if it does not meet the criteria (or added, e.g., if it does meet certain criteria). If no publishing rules are supplied at 510, then the list of possible content should remain unchanged as the process moves to blocks 512 and 513.

At block 512, a content post date range may be provided. Content can be restricted by a start date and/or an end date in order to limit in the time dimension when that content can be published. For example, a time-sensitive promotion may only last for a week, and therefore a post date range would be applied so that it only showed up when the promotion was valid. The post date range is optional.

Content may be filtered at block 513 by the post date range supplied at block 512. A post date range may be used to filter out the list remaining from blocks 501-511 of possible content outside the post date range, or to specifically include content having a post date range that includes the current active date. For each possible piece of content, it is determined at block 513 whether a current active date falls within the post date range. If the post date range is not supplied, then the list of possible content should remain unchanged.

At block 514, it is determined, after applying all the possible filters or selected filters to the list of possible content, whether there is any valid content remaining in the list. If the list of possible content is greater than zero, then the sub-process is determined to have been successful. Otherwise, the allocation algorithm is deemed to have failed in which case the sub-process may simply be skipped or it may be re-run with eased sensitivity as to its filtering criteria.

### Impression Allocation

A sub-process flow in accordance with certain embodiments to allocate impressions is illustrated in FIG. 6. At block 601, it is determined whether there are any existing reservations and/or a forecast for a particular destination. Existing reservations are reservations that are already allocated/reserved for this destination before this allocation algorithm started processing. The forecast is the estimated number of impressions that have been determined ought to be allocated for this destination. Under certain circumstances, the existing reservations and/or forecast can be changed to accommodate demand for priority impressions after the reservation or forecasts have been made assuming it is possible to do so from a technical, business and/or legal perspective.

At block 602, available space is calculated at a destination taking into account the reservations and forecast of block 501. The existing reservations are subtracted from the forecast to determine the available space at the destination.

At block 603, it is determined whether there is in fact any space available for impressions at the destination. If the available space at the destination is greater than zero, then the process moves to blocks 604 and 605. Otherwise, the allocation process may be skipped for this destination and this day or changes may be made to the existing reservations and/or the forecast. At block 604, an impression quota is provided. An impression quota is a maximum and/or minimum number of impressions to allocate for a certain campaign.

The number of impressions to allocate are now calculated at block 605. Based on the number of available impressions and the impression quota among other preferences, it is determined at 605 how many impressions will be allocated for a certain destination on a particular day or other range of dates or times, taking into account potentially other publishing restrictions.

At block 606 it is determined whether any allocations are available. If there are impressions available to allocate, then the process moves on to block 608. Otherwise, the allocation process may be skipped for this destination and this day, or changes may be made to make space by changing the quota, existing reservations and/or forecast, for example.

A number of pieces of content are determined at block 607. This is determined from the size of the list that is the output of the find content sub-process of FIG. 5.

Impressions are allocated at block 608 for each piece of content. Based on the number of pieces of content, among other preferences, it is determined how many impressions will be allocated to be assigned to each piece of content.

An ad network in accordance with certain embodiments may place ads based on demographics or context, and in addition or alternatively, may place ads based on detailed location information about consumers at certain locations or destinations for those ads. For example, the system can recognize that a consumer is using a WiFi hotspot in a hotel in New York, and then can dynamically insert information into an ad deemed pertinent to that consumer. The New York hotel guest might be assumed to be traveling, and could be served travel-related ads. The data can also be paired with contextual information.

User location information can be collected through a number of techniques, including whether a consumer is using a WiFi hotspot, a fixed broadband connection or a mobile device. It can then compare that information against the content a consumer is perusing, like maps, local news and/or weather. Comparing all the information it collects allows the system to identify the location or destination of a consumer and infer what they might be interested in based on that location or destination. For example, an airport or hotel-based user might be shown travel related ads, a residential user in an affluent neighborhood could be served ads for luxury automobiles. The system does not need to have personal information about the consumer to do this, and in certain embodiments, demographic inferences about a consumer, rather than specific personal information, are used in the process. A consumer may be in a particular place, perhaps at a particular time, such that there may be reasons inferred as to why the consumer is at that place at that time from that perspective of certain expected or predicted forms of behavior.

The determining of a consumer's location may be performed as a first step or one of two steps in a process that includes dynamic insertion of information into pertinent ads. An advertiser can run a national campaign with a central message and image, along with region specific information based on a user's location and/or other destination information. For example, a luxury car manufacturer can have the text of an ad updated to show the distance of the consumer from a nearest dealership. The ad may even call on the inventory at a local car dealership and state how many of a particular model, or color, are available. The system can use an advertiser's media along with place enablement, such that the message may be brought to the doorstep of the dealership that is closest to the consumer. An ad or other content can be localized or adapted to the individual viewing screen and/or audio output of a particular consumer, with or without any input as to specific personal information of that consumer.

The system is configured to gather information as to where people are and why they are there, such that dynamic ads can be placed without tracking the users themselves. The system can thereby generate uniquely relevant advertising campaigns. For example, three elements may be combined, including where the ad is seen, when it is seen, and information about that location, to determine a specific message for the audience demographic. The system uses information regarding the consumer's place of connection to do this.

### Place as More than Location

Every place can be deemed to be more than just a location in certain embodiments, i.e., consumers can be deemed to be in a particular place at a particular time or times, and for one or more particular reasons, and the audience demographic in a particular place can generally vary over time. For example, Madison Square Garden has a different audience during a teen idol concert than during a Knicks game, much like an airport's audience varies on weekdays versus weekends. A lot can be inferred from where a person is specifically located when going online. As another example, if a person is using a Wi-Fi hotspot in the lobby of a five-star hotel during a stockbroker conference, that person is likely to be interested in an ad for a fashion retailer, a luxury car or perhaps the jeweler down the street. He or she is not as likely to be interested in a coupon for the fast food restaurant three blocks away. The system gives advertisers the ability to find online audiences in the real world and then speak to them with messaging tailored to their location. The system permits the unification of an individual's real-time location with related local information. The result is hyper-targeted communications that match the likely or probable interests of the individual receiving the message, whether the person is at home, in an airport, at work, at a convention . . . or at The Plaza.

### Addressable and Dynamic Content

The system can position a consumer by recognizing an online connection, whether through a mobile device, DSL or cable access, or a Wi-Fi hotspot. Then, the system can combine position and supplemental information like type of venue, time and date, current events and local weather to infer the targeted audience. Once the probable audience is identified, the system can show targeted and localized messages in text, video or rich media format. The system can treat ad impressions and user location information as perishable inventory, and can leverage techniques from supply chain management.

In addition to the other references cited above herein, and the background, summary of the invention, and brief description of the drawings sections, the following are hereby incorporated by reference as disclosing alternative embodiments:
U.S. Pat. Nos. 6,487,538, 6,553,310, 6,983,313, 5,948,061, 6,795,700, 6,798,358, 6,799,032, 6,832,373, 6,845,400, 6,848,542, 6,819,267, 5,835,061, 5,969,678, 6,259,405, 6,326,918, 6,452,498, 6,697,018, 6,759,960, and 7,009,556, and US published applications nos. 2007/067969, 2007/0260531, 2007/0260741, 2004/0209602, 2003/0135581 and PCT/US2007/067966 U.S. patent applications Nos. 10/886,502, 60/746,209, 60/913,451, 60/913,444 and 60/746,216 which are by the same inventor as the present application, and www.1020systems.com, www.1020.com, www.freefinet.com, www.wifinder.com, and www.wi-fiplanet.com. Also, with regard to the embodiments illustrated and described above, particularly those with reference to FIGS. 2-6, alternative embodiments may include fewer than all of the shown and described elements.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

What is claimed is:

1. A method of publishing content to particular destinations, comprising:
(a) determining one or more probable destinations for publishing of electronic content to a group of one or more consumers of electronic content;
(b) inferring one or more probable demographics of the group based on the determining of probable destinations and one or more further characteristics relating to consumption of electronic content at said destination;
(c) selecting specific electronic content for the group according to the determining and inferring; and
(d) publishing said specific electronic content to one or more electronic devices of the group at one or more of said destinations.

2. The method of claim 1, further comprising allocating content impressions to be delivered.

3. The method of claim 2, wherein the allocating comprises limiting to an estimated number of impressions.

4. The method of claim 3, wherein the allocating comprises determining available impressions based on the estimated number minus a number of reserved allocations.

5. The method of claim 4, wherein the allocating comprises determining numbers of impressions to allocate for each selected item of content.

6. The method of claim 1, further comprising determining a particular date or time or range of dates or period of time, or combinations thereof, for consumption of specific electronic content by the group, and further basing said inferring in part on said date or dates or time or period of time, or combinations thereof.

7. The method of claim 6, further comprising excluding one or more particular dates or times, or both, for said consumption.

8. One or more processor-readable media having embodied therein program code for programming one or more processors to perform a method of publishing content to a particular destination as in any of claims 1-7.

9. A method of allocating content impressions to particular destinations, comprising:
(a) determining one or more probable destinations for allocating impressions of electronic content to a group of one or more consumers of electronic content, the destinations including one or more probable consumer venues, brands, types or categories of destinations, vendors, demographics, rendering device formats or templates, display devices, or form factors, or combinations thereof;
(b) selecting specific electronic content to deliver to the group based on the determining of probable destinations; and
(c) allocating one or more content impressions to one or more of said destinations according to the determining and selecting of the specific electronic content.

10. The method of claim 9, wherein the allocating comprises limiting to an estimated number of impressions.

11. The method of claim 10, wherein said limiting to an estimated number of impressions comprising limiting to said estimated number of impressions in a certain period of time.

12. The method of claim 9, wherein the allocating comprises determining available impressions based on the estimated number minus a number of reserved allocations.

13. The method of claim 12, wherein the allocating comprises determining numbers of impressions to allocate for each selected item of content.

14. One or more processor-readable media having embodied therein program code for programming one or more processors to perform a method of allocating content impressions to particular destinations as in any of claims 9-13.

15. The method of claim 1 or claim 9, further comprising limiting content impressions to a predetermined number or to a range of dates or times, or combinations thereof.

16. The method of claim 1 or claim 9, wherein the determining of probable destinations comprises filtering certain businesses or geographic locations, or both, from said probable destinations or allowing only certain businesses or geographic locations, or both, as probable destinations, or combinations thereof.

17. The method of claim 1 or claim 9, wherein the determining of probable destinations comprises filtering certain categories of destinations from said probable destinations or allowing only certain categories of destinations as probable destinations, or both.

18. The method of claim 17, wherein said categories of destinations comprise one or more hotels, bars, restaurants, airports, coffee shops, bookstores, or other types of businesses, or combinations thereof.

19. The method of claim 1 or claim 9, wherein the determining of probable destinations comprises filtering of certain destination vendors from said probable destinations or allowing only certain destination vendors as probable destinations, or both.

20. The method of claim 19, wherein said destination vendors comprise one or more entities associated with one or more networks that publish content to the consumers.

21. The method of claim 1 or claim 9, wherein the determining of probable destinations comprises filtering certain brands from said probable destinations or allowing only certain brands as probable destinations, or both.

22. The method of claim 21, wherein said brands comprise one or more entities associated with a property at which a destination is located.

23. The method of claim 1 or claim 9, wherein the determining of probable destinations comprises filtering destinations forecasted to result in less than a threshold number of impressions upon publication.

24. The method of claim 1 or claim 9, further comprising ordering the probable destinations based on predetermined values associated with one or more characteristics of the destinations.

25. The method of claim 24, wherein the one or more characteristics comprise one or more geographic locations, categories, brands, vendors, dates, times, or impression forecasts, or combinations thereof.

26. The method of claim 1 or claim 9, wherein the determining of probable destinations comprises assessing probable rendering device formats or templates, form factors, or display devices for publishing the content, or combinations thereof.

27. The method of claim 1 or claim 9, wherein the selecting of specific content comprises filtering location-aware content that fails to be within a predetermined geographic radius of the destination.

28. The method of claim 1 or claim 9, wherein the selecting of specific content comprises filtering one or more restricted content types.

29. The method of claim 28, wherein the selecting comprises selecting text content and the filtering comprises filtering image content.

30. The method of claim 28, wherein the selecting comprises selecting one or more images and the filtering comprises filtering text content.

31. The method of claim 28, wherein the selecting comprises selecting or filtering audio content.

32. The method of claim 1 or claim 9, wherein the selecting of specific content comprises filtering content having greater than a predetermined dimension.

33. The method of claim 1 or claim 9, wherein the selecting of specific content comprises filtering content according to one or more destination publishing rules.

34. The method of claim 1 or claim 9, wherein the selecting of specific content comprises filtering content according to one or more predetermined date criteria.

35. The method of claim 34, wherein said one or more predetermined date criteria comprises an end date, a date range, or a certain number of days or hours, or combinations thereof.

36. The method of claim 34, wherein said one or more predetermined date criteria comprises a promotional date range within a temporally-larger campaign.
